(19) United States
(12) Patent Application Publication
(10) Pub. No.: US 2005/0030658 A1
(43) Pub. Date: Feb. 10, 2005

(54) Color filter, color filter manufacturing method, display device, electro-optic device, and electronic instrument

(75) Inventors: Toshihiro Ushiyama, Chino-shi (JP); Hisashi Aruga, Nagano-ken (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjyuku-ku (JP)

(21) Appl. No.: 10/890,512

(22) Filed: Jul. 14, 2004

(30) Foreign Application Priority Data
Jul. 23, 2003 (JP) 2003-278432

(51) Int. Cl. G02B 5/22

(52) U.S. Cl. 359/891

(57) ABSTRACT

A color filter includes a light-transmissive substrate, a reflecting layer formed on the substrate and provided with openings, a boundary layer formed on the reflecting layer, and a plurality of light-transmissive layers enclosed by the boundary layer. The boundary layer includes a light-transmissive boundary layer portion that is disposed adjacent to the openings. With this arrangement, brightness and contrast of a display can be enhanced. Accordingly, it is possible to enhance the visibility of a color filter.

### BACKGROUND OF THE INVENTION

1. Field of the Invention

The present invention relates to a color filter with good visibility. More specifically, the present invention relates to a color filter, an electro-optic device such as display device having such color filter, an electronic instrument having such electro-optic device, and a manufacturing method for a color filter.

2. Background Information

A liquid crystal display device is known to be equipped with a color filter that functions both as a reflective display by using external light and a transmissive display by using a backlight. When such conventional liquid crystal display device functions as a reflective display, coloring light is obtained when the incoming light from outside passes through coloring layers that are provided for color-display purposes. Accordingly, the display is inevitably darkened because the incoming light is partially absorbed by the coloring layers. To prevent this problem, as disclosed in Japanese Laid-open Patent Application No. H11-183892, it has been known to provide in portions of the coloring layers colorless openings and reflecting films that correspond to the openings, such that part of the incoming light passes through the openings to be reflected at the reflecting films as colorless light without being absorbed by the coloring layers. By mixing the colorless light with the colored light, it is possible to obtain a brighter display than the case where all the incoming light passes through the coloring layers and becomes the colored light.

However, in order to implement the arrangement described above, it is necessary to form parts of the coloring layers as openings that act as non-coloring layers. In other words, the coloring layers must be formed so as to be divided into coloring components and non-coloring components.

Additionally, coloring layers are generally closely disposed next to one another. Accordingly, colors tend to be mixed due to two or more coloring layers overlapping one another, or gaps may be found in the outputted light because of gaps that are formed in between the coloring layers. This is a problem because such overlapped colors and gaps yield a display with poor contrast, not only in the case of a reflective display, but also in the case of a transmissive display as well.

Furthermore, when a user is viewing the liquid crystal display in the reflective mode, the user often sees the reflection of his/her face on the display. Such reflection makes it difficult for the user to view the display properly.

In view of the above, it will be apparent to those skilled in the art from this disclosure that there exists a need for an improved color filter, a color filter manufacturing method, a display device having such color filter, an electro-optic device having such color filter, and an electronic instrument having such color filter, that overcome the problems described above. This invention addresses this need in the art as well as other needs, which will become apparent to those skilled in the art from this disclosure.

### SUMMARY OF THE INVENTION

An object of the present invention is to provide a bright, good-contrast color filter with excellent visibility. Also an object of the present invention is to provide a method for manufacturing such color filter. It is further an object of the present invention to provide a display device, an electro-optic device, and an electronic instrument that have such color filter.

A color filter of a first aspect of the present invention includes a light-transmissive substrate, a reflecting layer formed on the substrate and provided with openings, a boundary layer formed on the reflecting layer, and a plurality of coloring layers enclosed by the boundary layer. The boundary layer includes a light-transmissive boundary layer portion that is disposed adjacent to the openings. The light-transmissive boundary layer portion is also preferably disposed at a plurality of locations that border adjacent coloring layers. Furthermore, the boundary layer preferably includes a non-light-transmissive boundary layer portion. The coloring layers are preferably formed by depositing droplets of a prescribed fluid that are discharged by a discharging device.

A color filter of another aspect of the present invention includes a light-transmissive substrate, a reflecting layer formed on the substrate and provided with openings, and a plurality of coloring layers formed on the reflecting layer. The reflecting layer on which the boundary layer is formed has an irregular surface that scatters light.

Preferably, the boundary layer of this color filter also includes a light-transmissive boundary layer portion and a non-light-transmissive boundary layer portion that enclose the openings. The light-transmissive boundary layer portion is preferably disposed at a plurality of locations that border adjacent coloring layers. The coloring layers are preferably formed by depositing droplets of a prescribed fluid with a discharging device. Furthermore, it is preferable that the overcoat layer be formed so that its thickness in the areas that correspond to the reflecting layer is greater than the thickness in other portions of the overcoat layer.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross-sectional view depicting the semi-light-transmissive reflecting liquid crystal display device in accordance with the first embodiment of the present invention;

FIG. 2 is a planar view depicting the arrangement of the boundary layers in the semi-light-transmissive reflecting liquid crystal display device;

FIG. 3 is an enlarged cross-sectional view of the periphery of the colored boundary layer;

FIG. 4 is a cross-sectional view depicting the semi-light-transmissive reflecting liquid crystal display device in accordance with the second embodiment of the present invention;

FIG. 5 is an enlarged cross-sectional view of the coloring layers according to the second embodiment of the present invention;

FIG. 6 is an external oblique view of the droplet-discharging device;

FIG. 7(a) is a planar view depicting the arrangement of the discharge heads and the nozzles;

FIG. 7(b) is a detail view depicting the structure of the discharge heads;

FIG. 8 is a cross-sectional view depicting the discharge of droplets onto the colored portion;

FIG. 9 is a schematic view depicting the manufacturing device for the liquid crystal display device;

FIG. 10 is a block diagram of the control system of the droplet-discharging device;

FIG. 11 is a process diagram depicting the manufacture of the color filter; and

FIG. 12 is a cross-sectional view depicting the electro-optic device in accordance with the third embodiment of the present invention;

FIG. 13 is a view of a wristwatch in accordance the fourth embodiment of the present invention, having a color filter in accordance with the first embodiment of the present invention; and

FIG. 14 is a view of a mobile telephone in accordance still another embodiment of the present invention, having a color filter in accordance with the second embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

A liquid crystal display device in accordance with embodiments of the present invention, which is a display device equipped with the color filter of the present invention, will be described hereinafter with reference to the accompanying drawings. This liquid crystal display device is an energy-conserving so-called semi-light-transmissive reflecting liquid crystal display device, which has a reflective display mode in which external light is let in to display images with reflected light of the external light, and a transmissive display mode in which images are displayed with light from a backlight. An optimal display mode in which images are to be displayed is determined based on brightness of the surroundings. The liquid crystal display device has color filters that have coloring layers for color-display purposes.

### First Embodiment

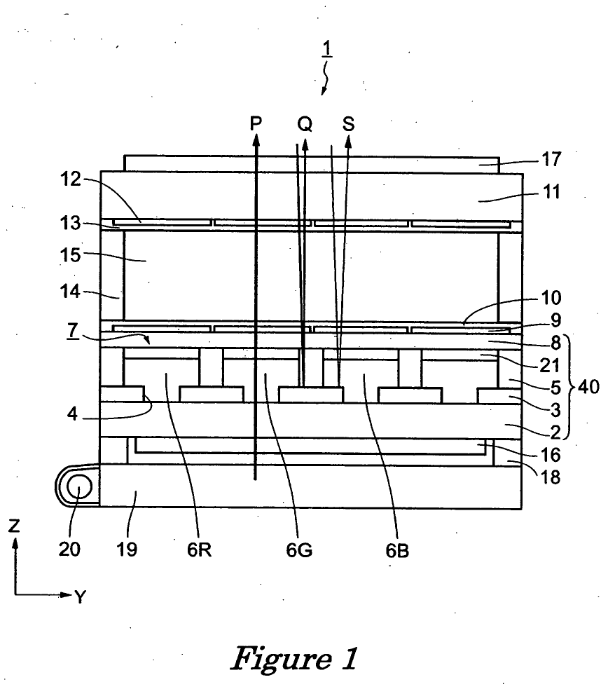

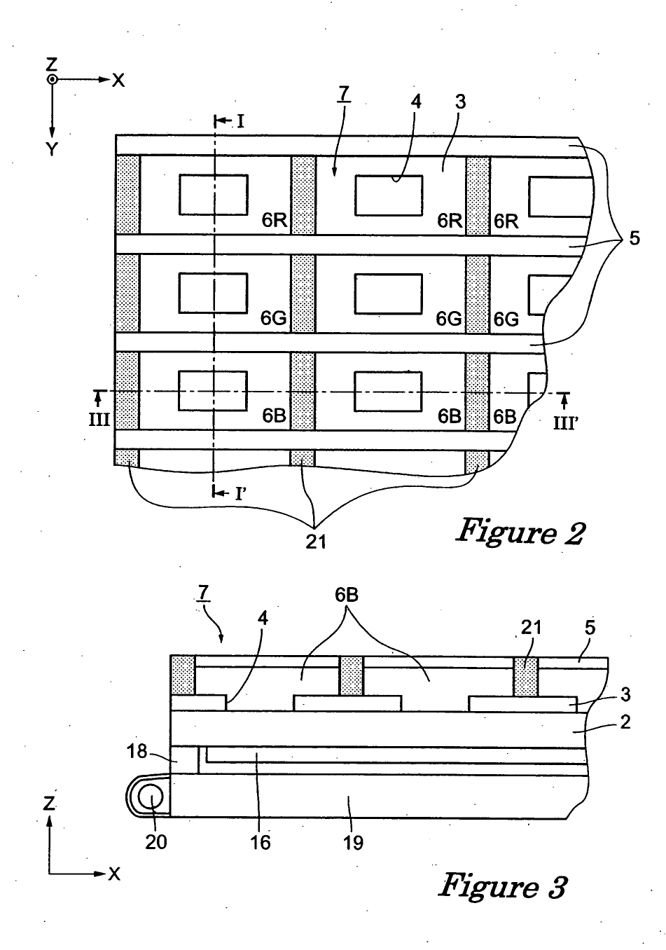

FIG. 1 is a cross-sectional view depicting the semi-light-transmissive reflecting liquid crystal display device according to the first embodiment of the present invention. In this cross-sectional view, a side of a liquid crystal 15 on which a light source 20 is disposed is referred to as a back side, and the opposite side as a front side. The contents being displayed are usually viewed from the front side. FIG. 2 is a diagram in which the positioning of boundary layers, which constitute a principal part of the invention, is depicted as viewed from the front side. As viewed in FIG. 2, a grid is formed with light-transmissive colorless boundary layers 5 that extend at a plurality of locations in the direction of the axis X, and non-light-transmissive colored boundary layers 21 that extend at a plurality of locations in the direction of the axis Y that is orthogonal to the axis X. FIG. 1 is a cross sectional view (I-I′) of the colorless boundary layers 5, while FIG. 3 is a cross sectional view (III-III′) of the colored boundary layers 21.

As depicted in FIGS. 1 and 3, the semi-light-transmissive reflecting liquid crystal display device 1 has a light-transmissive back substrate 2 and a front substrate 11 that are disposed facing each other, and a color filter 40 for color-display purposes. The color filter 40 includes the back substrate 2; a reflecting layer 3 having openings 4 formed on the front side of the back substrate 2; colorless boundary layers 5 and colored boundary layers 21 formed so as to enclose the openings 4 on the reflecting layer 3; a plurality of deposit portions 7 formed by the colorless boundary layer 5 and the colored boundary layer 21 such that a prescribed coloring fluid is applied thereto by a discharging device to be described below; coloring layers 6R, 6G, and 6B that are layers of the coloring fluid applied to the deposit portions 7; and an overcoat layer 8 for entirely covering the colorless boundary layer 5, colored boundary layer 21, and coloring layers 6R, 6G, and 6B.

Pixel electrodes 12 that are disposed so as to correspond to the coloring layers 6R, 6G, and 6B, and an orientation film 13 that covers the pixel electrodes 12 are formed on the back side of the front substrate 11. Counter electrodes 9 that are disposed opposite the pixel electrodes 12, and an orientation film 10 that covers the counter electrodes 9 are formed on the overcoat layer 8 described above. A seal 14 is formed along the external periphery of the front substrate 11 between the orientation film 10 and orientation film 13, and liquid crystal 15 is sealed in the space formed by the seal 14, the orientation film 10, and the orientation film 13. Also provided are a front-face polarizing plate 17 attached to the front side of the front substrate 11, a back-face polarizing plate 16 attached to the back side of the back substrate 2, an optical waveguide plate 19 provided via a buffer 18 so as to cover the entire back side of the back-face polarizing plate 16, and a light source 20 for supplying light to the optical waveguide plate 19.

The coloring layers 6R, 6G, and 6B are arranged in an orderly fashion in a lattice. Particularly in this embodiment, the coloring layers 6R, 6G, and 6B are arranged in a grid. Coloring layers 6 of the same color form a row in the X-axis direction, while coloring layers 6R, 6G, and 6B of different colors are aligned in the Y-axis direction. The colorless boundary layers 5 are arranged at the borders between coloring layers 6 of differing colors, while the colored boundary layers 21 are arranged at the borders between coloring layers 6 of the same color. In other words, both the colorless boundary layers 5 and colored boundary layers 21 are placed at the borders of the coloring layers 6R, 6G, and 6B. The coloring layers 6 are compartmentalized by the boundary layers 5 and 21. Therefore, it is possible to avoid problems such as poor color contrast that occurs due to colors overlapping each other or gaps being formed between the coloring layers 6. Accordingly it is possible to obtain sharp display. Here, the colorless boundary layer 5, the counter electrodes 9, the pixel electrodes 12, the orientation films 10 and 13, and the overcoat layer 8 are preferably also light-transmissive.

Reflective Display Mode

The reflective display mode of the semi-light-transmissive reflecting liquid crystal display device 1 thus configured will be described referring to FIG. 1. Among various external lights that enter the front-face polarizing plate 17, the front-face polarizing plate 17 lets only lights that are in the transmission direction (transmission axis direction), such as external lights Q and S, pass through. External lights that enter from other directions are absorbed by the front-face polarizing plate 17. Once the external lights Q and S have passed through the front-face polarizing plate 17, they further pass through: the pixel electrodes 12 orientation film 13→liquid crystal 15→orientation film 10→counter electrodes 9→overcoat layer 8, in this order. After the overcoat layer 8, the external light Q in this arrangement passes through the colorless boundary layer 5 and reaches the reflecting layer 3. The external light Q is then reflected by the reflecting layer 3 and again passes through the colorless boundary layer 5, eventually exiting from the front side as colorless light after passing through in a reverse order the layers through which it entered. On the other hand, the external light S in FIG. 1 passes through the coloring layer 6B and reaches the reflecting layer 3. The external light S is then reflected by the reflecting layer 3, and again passes through the coloring layer 6B. The external light S exits from the front side as colored light that is colored in the color of the coloring layer 6B, after passing through, in a reverse order, the layers from which it entered.

The external light S that has now become a colored light passes through the coloring layers 6 twice and is colored in a prescribed color up to a prescribed saturation. Lights colored in colors other than that of the designated coloration are absorbed by the coloring layers 6, and brightness is thereby reduced. Brightness tends to be further reduced if the thickness of the coloring layers 6 is increased in order to increase color saturation. However, because the colorless external light Q passes through the colorless boundary layer 5 without passing through the coloring layers 6, it exits without any change in its original brightness. Consequently, in order to increase the brightness of the external light S, the external lights Q and S are caused to exit from the front face simultaneously, and the overall brightness is maintained by their joint effects. The light that is brightened by mixing the colored light with the colorless light is recognized as colored light by human eyes, since human eyes cannot distinguish between colored light and the colorless light.

The colorless boundary layers 5 that have above-described effects are made of an acrylic resin or epoxy resin with good light transmission property, and are aligned along the boundaries between coloring layers 6 of different colors, such that the overall brightness of the coloring layers 6 is balanced and an easily readable display is obtained. The colored boundary layers 21 are resin-made and aligned along the boundaries between coloring layers 6 of the same color. The colored boundary layers 21 are black and therefore yield good color contrast. Also, since the colored boundary layers 21 are black, even when the depositing device that will be described below deposits colored fluid onto the colored boundary layers 21 during the process of manufacturing the coloring layers 6, it has no effect on the display. Accordingly, the colored fluid can be continuously discharged onto multiple coloring layers 6. Both of these colored and colorless boundary layers 5 and 21 are usually formed by a dispenser, screen printing, or the like. Specifically, in the present invention, light-transmissive banks (colorless boundary layers 5) are formed in a first area (boundary between coloring layers 6 of different colors) on the reflecting layer 3, while non-light-transmissive banks (colored boundary layers 21), which are light-blocking layers, are formed in a second area (boundary between coloring layers 6 of the same color), which is different from the first area.

The reflecting layer 3 formed on the back substrate 2 uses a thin film made of metals such as silver, aluminum, nickel, and chrome to reflect light. The overcoat layer 8 flattens irregular surfaces created during the formation of the colorless boundary layers 5, colored boundary layers 21, and coloring layers 6R, 6G, and 6B, and thereby facilitates formation of the counter electrodes 9. The orientation films 10 and 13 cover and protect the counter electrodes 9 and pixel electrodes 12, respectively, and are designed to prevent organic ingredients and the like from exuding into and degrading the liquid crystal 15.

In the liquid crystal 15, the orientation of liquid crystal molecules is varied according to the electric field applied between the pixel electrodes 12 and the counter electrodes 9 that are positioned to sandwich the liquid crystal 15 from front and rear sides, such that the transmitted light is controlled according to the orientation of the liquid crystal molecules. Consequently, the counter electrodes 9 and the pixel electrodes 12 are arranged in pairs in positions opposite the colorless boundary layers 5 of each of the coloring layers 6R, 6G, and 6B, such that the transmission and blockage of light and the brightness of each color are controlled to depict prescribed patterns. In the areas of the colorless boundary layers 5, each of the counter electrodes 9 that are disposed adjacent one another with a colorless boundary layers 5 in between is arranged to cover half the width of the colorless boundary layer 5. In other words, the counter electrodes 9 and pixel electrodes 12 are disposed such that the transmission, blockage, and the like of light applied to the external lights Q and S are the same. Also as seen in FIG. 1, the external lights Q and S also pass through the liquid crystal 15 twice.

Transmissive Display Mode

A brief description of the transmissive display mode will be given next. In the transmissive display mode, transmission light P emitted from the light source 20 is used instead of the external lights Q and S that are used in the reflective display mode. The transmission light P is guided to the back-face polarizing plate 16 by the optical waveguide plate 19, such that only light in the transmission direction (transmission axis direction) of the back-face polarizing plate 16 passes through the back-face polarizing plate 16. The resultant light that passed through the back-face polarizing plate 18 then passes through the back substrate 2 and enters the coloring layers 6R, 6G, and 6B through the openings 4. The transmission light P that entered the coloring layers 6R, 6G, and 6B is colored in the color of the coloring layers 6 in which the transmission light P entered, and exits from the front side passing through: the overcoat layer 8 counter electrodes 9 orientation film 10→liquid crystal 15→orientation film 13→pixel electrodes 12→front substrate 11→front-face polarizing plate 17. Usually, the transmission light P passes through the coloring layers 6 and liquid crystal 15 only once. There if the external light S that enters the front face and the transmission light P that comes out of the light source 20 are of the same brightness, the transmission light P will be brighter when it exits from the front face. The present invention is designed so that the brightness of the reflective display is increased by the addition of the bright external light Q to the external light S, so that the difference in brightness between the reflective display mode and the transmissive display mode is extremely small.

In this liquid crystal display device 1, by providing the boundary layers 5 and 21 at the boundaries of the coloring layers 6, the boundary layers 5 and 21 can be disposed and the coloring layers 6 can be compartmentalized in an orderly manner. Accordingly, it is possible to avoid random color overlaps between the coloring layers. As a result, color contrast can be enhanced. Also, incoming external light can become reflected light with minimal reduction in the brightness. Thus, the brightness of the display can also be enhanced.

### Second Embodiment

The liquid crystal display device in accordance with a second embodiment of the present invention will next be described. In view of the similarity between the first and second embodiments, the parts of the second embodiment that are identical to the parts of the first embodiment will be given the same reference numerals with a prime (′) as the parts of the first embodiment. Moreover, the descriptions of the parts of the second embodiment that are identical to the parts of the first embodiment may be omitted for the sake of brevity.

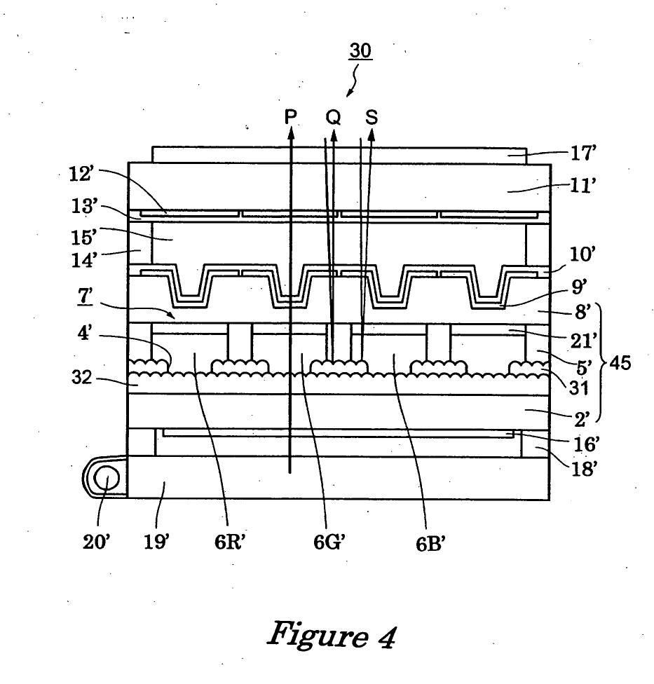

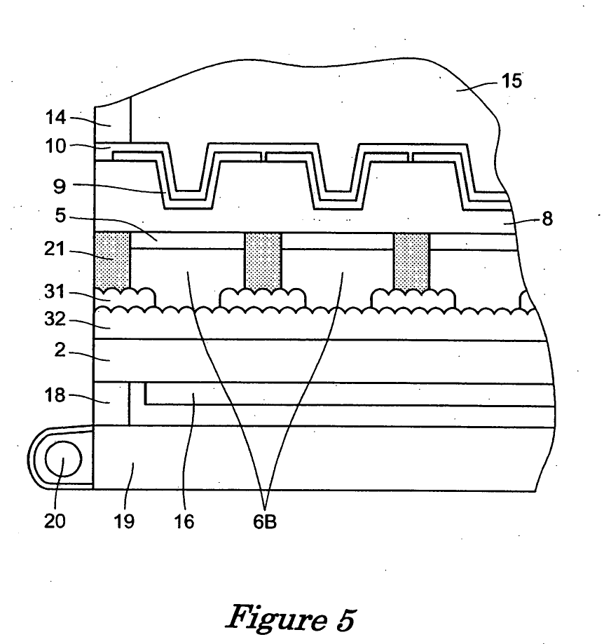

FIG. 4 is a cross-sectional view depicting the semi-light-transmissive reflecting liquid crystal display device 30 in accordance with the second embodiment of the present invention. As in the first embodiment, the side of the liquid crystal 15′ on which the light source 20′ is disposed is referred to as the back side, and the opposite side as the front side in this cross-sectional view. Also with regard to the arrangement of the boundary layers, a grid is formed with light-transmissive colorless boundary layers 5′ that extend in the direction of the X-axis at a plurality of locations and non-light-transmissive colored boundary layers 21′ that extend in the direction of the Y-axis at a plurality of locations as in the first embodiment depicted in FIG. 2. FIG. 4 is a diagram depicting a cross section (I-I′) of the colorless boundary layers 5′, while FIG. 5 is a diagram depicting a cross section (III-III′) of the colored boundary layers 21′. This embodiment differs from the first embodiment in that a resin scattering layer 32 is additionally provided on the back substrate 2′, that the reflecting layer 3 is replaced with a scattering and reflecting layer 31 whose front face has an irregular shape, and that the thickness of the overcoat layer 8′ is partially changed.

As depicted in FIGS. 4 and 5, the semi-light-transmissive reflecting liquid crystal display device 30 includes a light-transmissive back substrate 2′ and a front substrate 11′ that are disposed opposite each other, and a color filter 45 for color display purposes. The color filter 45 includes a resin scattering layer 32 which is formed on the front side of the back substrate 2′ and has an irregular surface on the front side; a scattering and reflecting layer 31 which has an irregular surface for scattering light and openings 4′ formed on its front face; colorless boundary layers 5′ and colored boundary layers 21′ which are formed so as to enclose the openings 4′ of the scattering and reflecting layer 31; a plurality of deposit portions 7′ which is defined by the colorless boundary layers 5′ and the colored boundary layers 21′ and to which a prescribed colored fluid is applied by a discharging device to be described later; coloring layers 6R′, 6G′, and 6B′ which are formed by depositing colored fluid to the deposit portions 7′; and an overcoat layer 8′ that is designed to completely cover the colorless boundary layers 5′, colored boundary layers 21′, and the coloring layers 6R′, 6G′, and 6B′, and is formed with different thickness such that portions 8′a of the overcoat layer 8′ that are above the scattering and reflecting layer 31 are thicker than other portions of the overcoat layer 8′.

Pixel electrodes 12′ disposed corresponding to the coloring layers 6R′, 6G′, and 6B′, and an orientation film 13′ for covering the pixel electrodes 12′ are provided on the back of the front face substrate 11′. Counter electrodes 9′ are disposed in a concave tail-like shape opposite the pixel electrodes 12′. An orientation film 10′ that covers the counter electrodes 9′ is provided on the overcoat layer 8′ described above. A seal 14′ is formed along the external periphery of the front substrate 11′ between the orientation films 10′ and 13′, and liquid crystal 15′ is sealed in the space formed between the seal 14′ and the orientation films 10′ and 13′. Also provided are a front-face polarizing plate 17′ attached to the front side of the front substrate 11′, a back-face polarizing plate 16′ attached to the back side of the back substrate 2′, an optical waveguide plate 19′ provided via a buffer 18′ so as to cover the entire back side of the back-face polarizing plate 16′, and a light source 20′ for supplying light to the optical waveguide plate 19′.

The coloring layers 6R′, 6G′, and 6B′ are arranged in an orderly fashion in a grid. Coloring layers 6′ of the same color form a row in the X-axis direction, while coloring layers 6R′, 6G′, and 6B′ of different colors are aligned in the Y-axis direction. The colorless boundary layers 5′ are arranged at the borders between coloring layers 6′ of different colors, while the colored boundary layers 21′ are arranged at the borders of coloring layers 6′ of the same color. The colorless boundary layers 5′, the counter electrodes 9′, the pixel electrodes 12′, the orientation-films 10′ and 13′, the overcoat layer 8′, and the scattering layer 32 are also light-transmissive.

Reflective Display Mode

First, the reflective display mode of the semi-light-transmissive reflecting liquid crystal display device 30 thus configured will be described. Among various external lights that enter the front-face polarizing plate 17′, only lights that are in the transmission direction (transmission axis direction), such as external lights Q and S, are allowed to pass through the front-face polarizing plate 17′. Once the external lights Q and S have passed through the front-face polarizing plate 17′, they further pass through: pixel electrodes 12′ ) orientation film 13′→liquid crystal 15′→orientation film 10′→counter electrodes 9′→overcoat layer 8′, in this order. After the overcoat layer 8′, the external light Q in this arrangement passes through the colorless boundary layer 5′ and reaches the scattering and reflecting layer 31. The external light Q is then reflected by the scattering and reflecting layer 31 and again passes through the colorless boundary layer 5′, eventually exiting from the front side as colorless light after passing through in a reverse order the layers through which it entered. On the other hand, the external light S in FIG. 1 passes through the coloring layer 6B′ and reaches the scattering and reflecting layer 31. The external light S is then reflected by the scattering and reflecting layer 31 and again passes through the coloring layers 6B′. The external light S exits from the front side as colored light that is colored in the color of the coloring layer 6B′, after passing through, in a reverse order, the layers from which it entered.

In this arrangement, the external lights Q and S are scattered in various directions by the irregular surfaces of the scattering and reflecting layers 31 when they are reflected at the scattering and reflecting layers 31. Accordingly, an image from the incoming direction of the light, such as reflection of viewer's eyes, face, or the like that occurs on the display when there is no irregular surface in the reflecting layer is thereby prevented, and a clearer display is obtained. This scattering and reflecting layers 31 are made of a thin film of silver, aluminum, nickel, chrome, or the like to reflect light, and irregularities are provided on its surface by etching, oxygen plasma treatment, or the like to scatter light. Furthermore, although almost no external light that enters the openings 4 is reflected, a resin scattering layer 32 is provided and irregularities are provided to its front face in order to prevent slight reflections and to yield an even clearer display.

The external light S that has now become a colored light twice passes through the coloring layer 6′, is colored with a prescribed color up to a prescribed color saturation. Accordingly, the external light S has inevitably reduced its brightness, whereas the external light Q that has passed through the colorless boundary layer 5′ without passing through the coloring layers 6′ and exited as a colorless light maintains its original brightness. Consequently, in order to increase the brightness of the external light S, the external light Q and the external light S are caused to exit from the front face simultaneously, such that the overall brightness is maintained. The colorless boundary layers 5′ having such effects are preferably made of an acrylic resin or epoxy resin with good light-transmission property and are aligned in an orderly fashion at the boundaries between the coloring layers 6′ of differing colors. Accordingly, the overall brightness of the coloring layers 6′ is balanced and an easily readable display is obtained. The colored boundary layers 21′ formed at the boundaries between coloring layers 6′ of the same color are black and yield a good color contrast.

The portions 8′a of the overcoat layer 8′ that correspond to the scattering and reflecting layers 31 are formed thick in order to sustain the brightness of the external light Q and S that are scattered and reflected by the scattering and reflecting layer 31. By forming the portions 8′a thicker, the thickness of the layer of the liquid crystal 15′ through which the external light Q and S are transmitted after being reflected by the scattering and reflecting layer 31 becomes shorter. Accordingly, reduction of brightness due to the passage through the liquid crystal 15′ is thereby reduced, and the brightness of the external lights Q and S when they exit from the front can be enhanced.

Transmissive Display Mode

The manner in which the semi-light-transmissive reflecting liquid crystal display device 30 of the present embodiment functions in the transmissive display mode is substantially the same as the foregoing semi-light-transmissive reflecting liquid crystal display device 1 described above. Accordingly, detailed description of the semi-light-transmissive reflecting liquid crystal display device 30 in the transmissive display mode is omitted herein. In the semi-light-transmissive reflecting liquid crystal display device 30 of this embodiment, however, the overcoat layer 8′ and the liquid crystal 15′ are designed such that the length of the liquid crystal 15′ through which the external light Q and S are transmitted is shortened to reduce the amount of reduction in brightness as described above. Accordingly, if the brightness of the-incoming external light Q and S is the same as the brightness of the transmission light P at the light source 20′, there will be very little difference in brightness between the transmission light P and the external light Q and S at the time they are emitted from the front face. In other words, the semi-light-transmissive reflecting liquid crystal display device 30 of the present has a good display balance substantially eliminating the difference in the variance in brightness between the transmission light P and the external lights Q and S.

The semi-light-transmissive reflecting liquid crystal display devices 1 and 30 are also capable of providing an optimum display mode. More specifically, when the device is used in a bright setting, images are displayed on the reflective display mode by using external light Q and S, while images are displayed on the transmissive display mode using the transmission light P of the internal light source 20′ when the device is used in a dark setting.

Manufacturing Methods

In the semi-light-transmissive reflecting liquid crystal display devices 1 and 30 described in the first and second embodiments, the coloring layers 6R, 6G, and 6B can be formed uniformly and effectively by depositing droplets of colored fluid onto the deposit portions 7 to with a droplet-discharging device. In this manner, it is possible to form the coloring layers having uniform thickness and coverage. Additionally, the overcoat layer 8 may also be formed with a similar droplet-discharging device.

Droplet Discharging Device 100

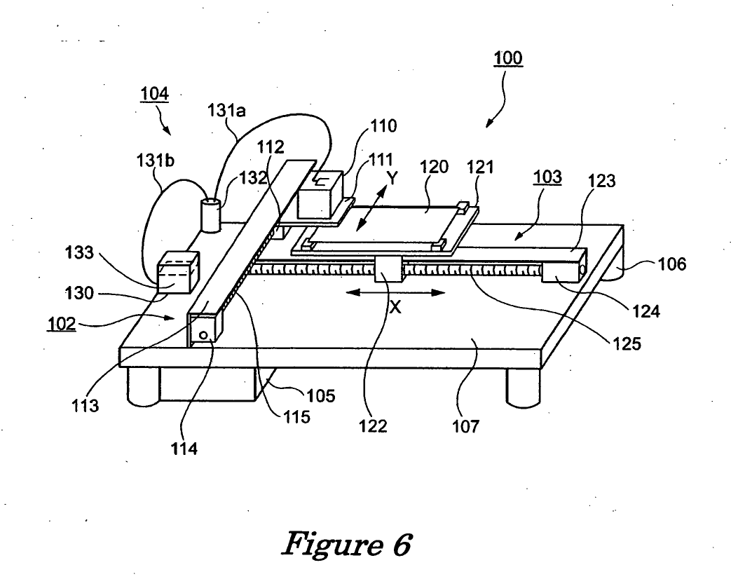

As depicted in FIG. 6, a droplet-discharging device 100 includes a head mechanism 102 having a head unit 110 for discharging droplets; a work mechanism 103 for supporting a work 102 so that droplets can be discharged onto a discharge target of a work 120 from the head unit 110; a fluid feeding unit 104 for feeding fluid 133 to the head unit 110; and a controller 105 and a drive unit 175 for performing overall control of these mechanisms and the feeding unit.

The droplet-discharging device 100 is further provided with a plurality of support legs 106 placed on the floor, and a table 107 attached to the tops of the support legs 106. At the top of the table 107, the work mechanism 103 is disposed so as to extend in the longitudinal direction (X-axis direction) of the table 107. The head mechanism 102 supported by two pillars that are provided on the table 107 is disposed above the work mechanism 103 so as to extend in the direction orthogonal to the work mechanism 103 (in the Y-axis direction). A fluid feeding unit 104 for feeding the fluid 133 is connected from the head unit 110 of the head mechanism 102 and is disposed on one end of the table 107. Furthermore, the controller 105 is accommodated on the underside of the table 107.

The head mechanism 102 is provided with a head unit 110 for discharging the fluid 133, a carriage 111 on which the head unit 110 is mounted, a Y-axis guide 113 for guiding the movement of the carriage 111 in the Y-axis direction, a Y-axis bore screw 115 mounted in the Y-axis direction under the Y-axis guide 113, a Y-axis motor 114 for rotating the Y-axis bore screw 115 forward and backward, and a carriage screwing unit 112 at the bottom of the carriage 111 in which a female screw is formed for engaging with the Y-axis bore screw 115 and moving the carriage 111.

The work mechanism 103 is positioned below the head mechanism 102. The work mechanism 103 has substantially the same structure as the head mechanism 102, except that the work mechanism 103 is disposed in the X-axis direction. The work mechanism 103 is composed of a work 120, a mounting platform 121 on which the work 120 is mounted, an X-axis guide 123 for guiding the movement of the mounting platform 121, an X-axis bore screw 125 mounted under the X-axis guide 123, an X-axis motor 124 for rotating the X-axis bore screw 125 forward and backward, and a mounting platform screwing unit 122 at the bottom of the mounting platform 121 for engaging with the X-axis bore screw 125 and moving the mounting platform 121.

Although not shown in the Figures, position detection devices for detecting the positions to which the head unit 110 and mounting platform 121 have moved are provided to each of the head mechanism 102 and the work mechanism 103. The carriage 111 and work table 121 each have a mechanism for adjusting the rotational axis (so-called θ axis) built therein, thereby allowing the adjustment of the rotational axis of work table 121 as well as the adjustment of the rotational axis of the head section 110 about its center.

Due to these configurations, the head unit 110 and the work 120 can be moved back and forth in the Y-axis and X-axis directions. The movement of the head unit 110 will first be described. The Y-axis bore screw 115 is rotated forward and backward by the forward and backward rotation of the Y-axis motor 114, and the carriage 111 that is fixedly attached to the carriage screwing unit 112 can be moved to any position by moving the carriage screwing unit 112 that is threadedly coupled to the Y-axis bore screw 115 along the Y-axis guide 113. In other words, the head unit 110 mounted on the carriage 111 can move freely in the Y-axis direction by driving the Y-axis motor 114. In the same manner, the work 120 mounted on the mounting platform 121 can also move freely in the X-axis direction.

In this manner, the head unit 110 is moved up along the Y-axis to the discharge position and stopped, such that droplets are discharged as the work 120 below is moved in the X-axis direction. Accordingly, a desired pattern can be formed on the work 120 by controlling the work 120, which moves in the X-axis direction, and the head unit 110, which moves in the Y-axis direction, relative to each other.

The fluid feeding unit 104 for feeding the fluid 133 to the head unit 110 is composed of a tube 131a that forms a flow channel to the head unit 110; a pump 132 for pumping fluid to the tube 131a; a tube 131b (flow channel) for feeding the fluid 133 to the pump 132; and a tank 130 for storing the fluid 133. The tank 130 is connected to the tube 131b and is disposed at one end on the table 107.

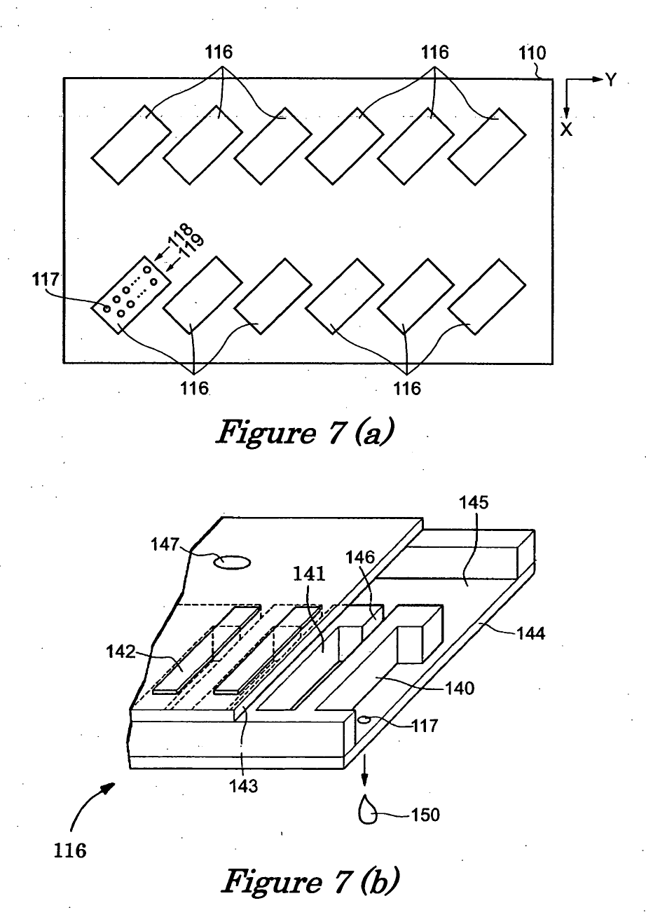

As depicted in FIG. 7(a), the head unit 110 contains a plurality of discharge heads 116 having the identical structure. FIG. 7(a) is a diagram depicting the head unit 110 as viewed from the mounting platform 121. Two rows of six discharge heads 116 are arranged in the head unit 110 such that the longitudinal direction of each of the discharge heads 116 is at an angle with respect to the X-axis direction. Each of the discharge heads 116 that discharge the fluid 133 also has two nozzle rows 118 and 119 extending in the longitudinal direction of the discharge head 116. Each of the nozzle rows 118 and 119 has 180 of nozzles 117 lined up in a row, and the interval between the nozzles 117 along the direction of the nozzle rows 118 and 119 is approximately 140 μm. The nozzles 117 between the two nozzle rows 118 and 119 are arranged so as to be offset by a half-pitch (approximately 70 μm).

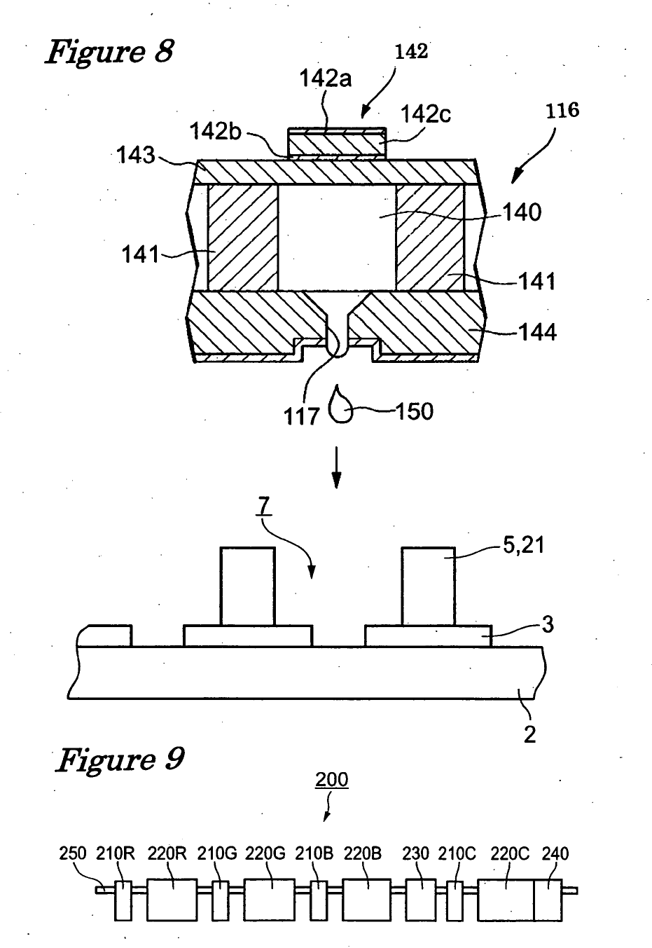

As depicted in FIGS. 7(b) and 8, each of the discharge heads 116 is provided with a diaphragm 143 and a nozzle plate 144. A fluid reservoir 145 that is continually filled with the fluid 133 fed from the tank 130 via a hole 147 is positioned between the diaphragm 143 and the nozzle plate 144. A plurality of barriers 141 are also positioned in the space between the diaphragm 143 and the nozzle plate 144. The area enclosed by the diaphragm 143, the nozzle plate 144, and a pair of barriers 141 constitutes a cavity 140. The cavity 140 is provided for each of the nozzles 117, so the number of cavities 140 is the same as the number of nozzles 117. The fluid 133 is fed to the cavities 140 from the fluid reservoir 145 via a feeding port 146 positioned between the pair of barriers 141.

As depicted in FIGS. 7(b) and 8, a transducer 142 is positioned opposite each of the cavities 140 on the diaphragm 143. The transducer 142 is composed of a piezoelement 142c and a pair of electrodes 142a and 142b that sandwich the piezoelement 142c. The fluid 133 is formed into droplets 150 and discharged from corresponding nozzles 117 as a drive voltage is applied to the pair of electrodes 142a and 142b. In the case of the semi-light-transmissive reflecting liquid crystal display devices 1 and 30 discussed above, the droplets 150 of colored fluid are discharged onto the deposit portions 7 enclosed by the colorless and colored boundary layers 5 and 21, thereby creating the coloring layers 6R, 6G, and 6B.

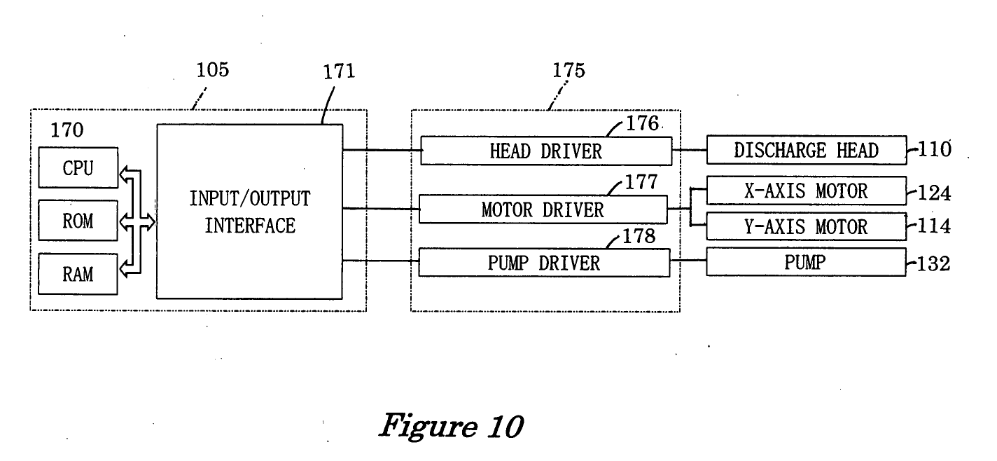

The control system for controlling the configuration described above will next be described with reference to FIG. 10. The control system is provided with a controller 105 and a drive unit 175. The controller 105 is composed of a CPU 170, ROM, RAM, and an input/output interface 171. The CPU 170 processes various signals inputted via the input/output interface 171 based on data in the ROM and RAM, outputs a control signal to the drive unit 175 via the input/output interface 171, and selectively controls each component operatively connected to the control system. It will be apparent to those skilled in the art from this disclosure that the precise structure and algorithms for controller 105 can be any combination of hardware and software that will carry out the functions of the present invention.

The drive unit 175 is composed of a head driver 176, a motor driver 177, and a pump driver 178. The motor driver 177 rotates the X-axis motor 124 and the Y-axis motor 114 through the control signal of the controller 105, to control forward and backward movement of the work 120 and the head unit 110. The head driver 176 controls discharge of the fluid 133 from the discharge heads 116 while synchronizing with the control of the motor driver 177, such that a desired pattern can be formed on the work 120. The pump driver 178 controls the pump 132 in coordination with the discharge state of the fluid 133 and optimally controls the fluid supply to the discharge heads 116.

The controller 105 is configured to send a separate signal to each of the plurality of transducers 142 via the head driver 176. The volume of droplets 150 to be discharged from the nozzles 117 is thereby controlled for each of the nozzles 117 according to the signal from the head driver 176. Furthermore, the volume of droplets 150 discharged by each of the nozzles 117 can be varied between 0 pL and 42 pL (pico liters).

Manufacturing Method of Color Filter 40

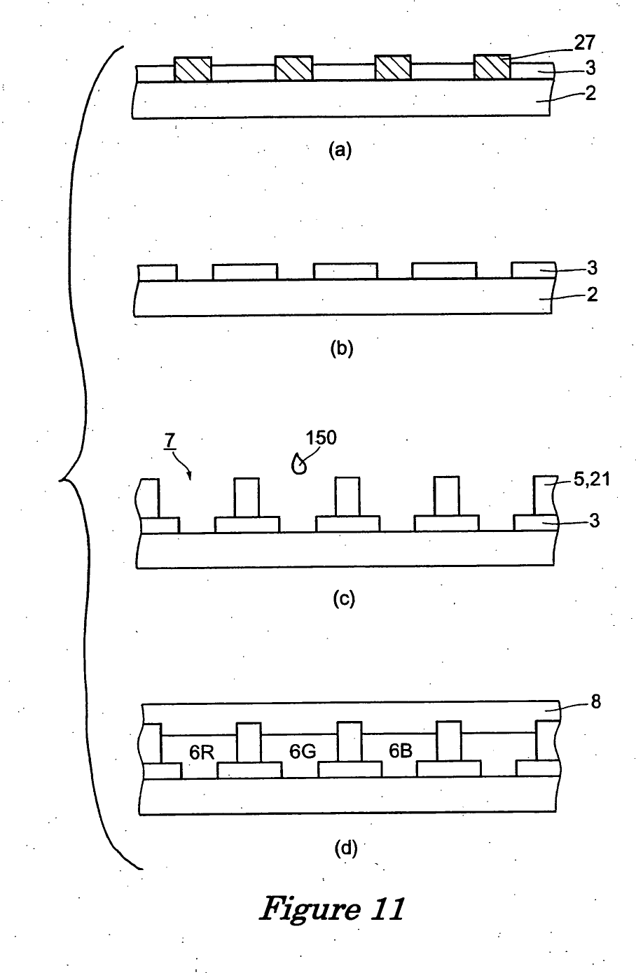

The manufacturing method of the color filter 40 in accordance with the first embodiment will be described in detail with reference to FIG. 11. The color filter 40 includes the back substrate 2, the reflecting layer 3, openings 4, colorless boundary layer 5, colored boundary layer 21, deposit portions 7, coloring layers 6R, 6G, and 6B, and overcoat layer 8. First, as depicted in FIG. 11(a), an organic resist film 27 for forming the openings 4 is formed on the front face of the back substrate 2, and an aluminum, chrome, or other metallic thin film for forming the reflecting layer 3 is formed thereon by vapor deposition or the like. The metallic thin film is bonded to the back substrate 2, but is not bonded to the resist film 27. The resist film 27 and the metallic thin film on the resist film 27 are removed by a solvent after the metallic thin film is formed, whereupon the reflecting layer 3 is formed as depicted in FIG. 11(b). The colorless boundary layer 5 composed of an acrylic or other light-transmissive resin, and the colored boundary layer 21 composed of a black resin form a grid as depicted in FIG. 2 on the reflecting layer 3, by screen printing or the like. Accordingly, the deposit portions 7 that are enclosed by the back substrate 2, the reflecting layers 3, the colorless boundary layer 5, and the colored boundary layer 21 are formed as depicted in FIG. 11(c).

The method whereby the droplets 150 of colored fluid are discharged by the droplet-discharging device 100 onto the deposit portions 7 to form the coloring layer 6 will be described using an example whereby red colored fluid is discharged to form a coloring layer 6R. First, the back substrate 2 on which the reflecting layer 3, colorless boundary layer 5, and colored boundary layer 21 are formed is mounted on the mounting platform 121 as the work 120, such that the direction in which the colorless boundary layer 5 extends is the X-axis and the direction in which the colored boundary layer 21 extends is the Y-axis, as depicted in FIG. 2. Droplets 150 of red colored fluid are discharged from the nozzle 117 as depicted in FIG. 8. The discharge head 116 moves in the X-axis direction from one end to the other end and deposit droplets 150 one by one to each of the deposit portions 7 of the red coloring layers 6R that are lined up in the X-axis direction. It is also possible to simultaneously deposit droplets 150 from another nozzle 117 to deposit portions 7 of another row of red coloring layer 6R. A red coloring layer 6R is completed by repeating this operation a number of times. The number of times this operation needs to be repeated depends on the number of rows of deposit portions 7 of the red coloring layers 6R.

In this case, the boundaries between the red coloring layers 6R are the non-light-transmissive colored boundary layers 21 extending in the Y-axis direction. Thus, there is no effect on the performance of the display device even if droplets 150 land on the colored boundary layer 21. Therefore, discharge of droplets in the X-axis direction can be performed continuously and efficiently without having to avoid the colored boundary layer 21. On the other hand, the boundaries between the green coloring layers 6G and the blue coloring layers 6B in adjacent rows are the colorless boundary layers 5, so droplets 150 must be prevented from landing thereon. However, since the colorless boundary layers 5 are parallel to the X-axis, and the nozzles 117 move only in the X-axis direction, it is easy to prevent the nozzles 117 and the colorless boundary layers 5 from intersecting. In a conventional arrangement, where an uncolored portion is provided inside each of the deposit portions 7 and is made to perform the functions of the colorless boundary layer 5 of the present invention, discharge of droplets had to avoid the uncolored portion at each discharge of droplets 150 to the deposit portions 7. Accordingly, it was difficult to control discharge of droplets. The arrangement of the colorless boundary layers 5 of the present invention in this manner facilitates the depositing process of the droplets.

The aforementioned method of manufacturing the red coloring layer 6R also applies to manufacturing method of the blue and green coloring layers 6G and 6B. After the coloring layers 6R, 6G, and 6B are formed as described above, the overcoat layer 8 is provided so as to cover the coloring layers 6R, 6G, and 6B, the colorless boundary layer 5, and the colored boundary layer 21. In this manner, manufacturing of the color filter 40 is thus completed.

Manufacturing Method of Color Filter 45

The manufacturing method of the color filter 45 of the second embodiment is basically the same as that of the color filter 40 of the first embodiment. Therefore, only the main differences between the two methods will be described. A light-transmissive resin scattering layer 32 provided with an irregular front face is affixed over the entire front side of the back substrate 2, and a resist film 27 and a scattering and reflecting layer 31 are formed on the resin scattering layer 32. The scattering and reflecting layer 31 in this embodiment is a metallic thin film, and is therefore formed so as to follow concavities and convexities of the surface of the resin scattering layer 32. Additionally, further irregularity is provided to the surface of the scattering and reflecting layer 31 by oxygen plasma treatment or the like to enhance its scattering effects. The process of removing the resist film 27 from the substrate 2 and subsequent processes are substantially identical to those of the manufacturing method of the color filter 40 in accordance with the first embodiment. Therefore, detailed description of these processes will be omitted herein.

Manufacturing Apparatus 200

An explanation follows for manufacturing apparatus that will be useful in forming coloring layers 6R, 6G and 6B efficiently using droplet-discharging device droplet 100. The manufacturing apparatus 200 for manufacturing the semi-light-transmissive reflecting liquid crystal display devices 1 and 30 depicted in FIG. 9 is a group of devices that includes the droplet-discharging device 100 of the third embodiment for discharging the droplets 150 of a corresponding colored fluid to each of the coloring layers 6R, 6G, and 6B in FIGS. 1 and 4. The manufacturing apparatus 200 is provided with a discharging device 210R for applying red colored fluid to all of the coloring layers 6R to which red colored fluid needs to be applied; a drying device 220R for drying the colored fluid of the coloring layers 6R; a discharging device 210G for applying green colored fluid to all of the coloring layers 6G to which green colored fluid needs to be applied; a drying device 220G for drying the colored fluid of the coloring layers 6G; a discharging device 210B for similarly applying blue colored fluid to all of the coloring layers 6B to which blue colored fluid needs applied; a drying device 220B for drying the blue colored fluid of the coloring layers 6B; an oven 230 for reheating (post-baking) the colored fluids of each color; a discharging device 210C for providing the overcoat layer 8 on the post-baked layer of colored fluid; a drying device 220C for drying the overcoat layer 8; and a curing device 240 for reheating and curing the dried overcoat layer 8. The manufacturing apparatus 200 is further provided with a transport device 250 for transporting the coloring layers 6R, 6G, and 6B through: the discharging device 210R, the drying device 220R, the discharging device 210G, the drying device 220G, the discharging device 210B, the drying device 220B, the oven 230, the discharging device 210C, the drying device 220C, and the curing device 240, in this order.

The same droplet-discharging device 100 may be utilized as the discharging device 210R, the discharging device 210G, the discharging device 2101B, and as the discharging device 210C. In this case, the head unit 110 of the droplet-discharging device 100 may be configured to discharge through the discharge heads 116 droplets of one of the colored fluid of red (R), green (G), and blue (B) or the overcoat. For example, the droplet-discharging device 100 performs the function of the discharging device 210R of the manufacturing apparatus 200 to manufacture the red coloring layer 6R by filling the discharge heads 116 with red colored fluid. The droplet-discharging device 100 performs the function of the discharging device 210G of the manufacturing apparatus 200 to manufacture the green coloring layer 6G by filling the discharge heads 116 with green colored fluid. The droplet-discharging device 100 also performs the function of the discharging device 2101B or the discharging device 210C of the manufacturing apparatus 200 to manufacture the blue coloring layer 6B or the overcoat layer 8 by filling the discharge heads 116 with blue colored fluid or overcoat fluid.

Furthermore, manufacturing apparatus 200 can also have devices for forming colorless boundary layers 5 and colored boundary layers 21, devices for forming the orientation films 10 and 13 of the semi-light-transmissive reflecting liquid crystal display devices 1 and 30, and a device for applying the liquid crystal 15. The colorless boundary layers 5 and colored boundary layers 21 of the color filters 40 and 45, which are formed with a dispenser or by screen printing, and the orientation films 10 and 13 of the semi-light-transmissive reflecting liquid crystal display devices 1 and 30 can be formed, and the liquid crystal 15 can be applied with the same droplet-discharging device 100.

Manufacturing Method of Semi-light-transmissive Reflecting Liquid Crystal Display

The manufacturing method for the semi-light-transmissive reflecting liquid crystal display devices 1 and 30, on which the color filter 40 or 45 of the first or second embodiment are mounted as described in the foregoing, will be described using the semi-light-transmissive reflecting liquid crystal display device 1 of FIG. 1 as an example. First of all, the color filter 40 that includes the back substrate 2, reflecting layer 3, openings 4, colorless boundary layer 5, colored boundary layer 21, deposit portion 7, coloring layers 6R, 6G, and 6B, and overcoat layer 8 is provided. Then, counter electrodes 9 composed of light-transmissive ITO (indium tin oxide) are formed on the overcoat layer 8 of the color filter 40 so as to correspond to each of the coloring layers 6. Furthermore, an orientation film 10 made of polyimide or the like is formed covering the entire surface of the counter electrodes 9 and overcoat layer 8. This way, the back substrate side of the semi-light-transmissive reflecting liquid crystal display device is completed.

On the other hand, pixel electrodes 12 composed of the same ITO as the counter electrodes 9 and arranged in positions opposite the counter electrodes 9 are formed on the back side of the front substrate 11. An orientation film 13 made of polyimide or the like is formed covering the entire surface of the pixel electrodes 12 and the front substrate 11 to provide a finish to the front substrate 17. A rectangular seal 14 having a notch in a portion thereof and defining areas in which the liquid crystal 15 is to be disposed is formed by screen printing or the like on the orientation film 10. The liquid crystal 15 that is maintained at a temperature suitable for discharge is discharged from the nozzles 117 of the discharge heads 116 to the inside of the seal 14 by using the droplet-discharging device 100. After the liquid crystal 15 is filled, the surface of the orientation film 13 of the front substrate 11 is bonded to the seal 14, and the notch of the seal 14 is sealed after the liquid crystal leaking from the notch is removed. The liquid crystal 15 to be deposited at this time is preferably 100% to 110% of the volume of the liquid crystal area so that gaps do not form in the liquid crystal area or an extra leakage does not occur.

The front-face polarizing plate 17 and back-face polarizing plate 16 are then bonded to the front substrate 11 and the back substrate 2, respectively. A buffer 18 is further provided on the periphery of the back-face polarizing plate 16. An optical waveguide plate 19 is affixed to the buffer 18 so as to face the entire surface of the back-face polarizing plate 16. A light source 20 is then disposed so as to be directly connected with the optical waveguide plate 19. A semi-light-transmissive reflecting liquid crystal display device 1 having excellent color contrast is thus manufactured. The same manufacturing process is performed for the semi-light-transmissive reflecting liquid crystal display device 30, which further includes the resin scattering layer 32.

### Third Embodiment

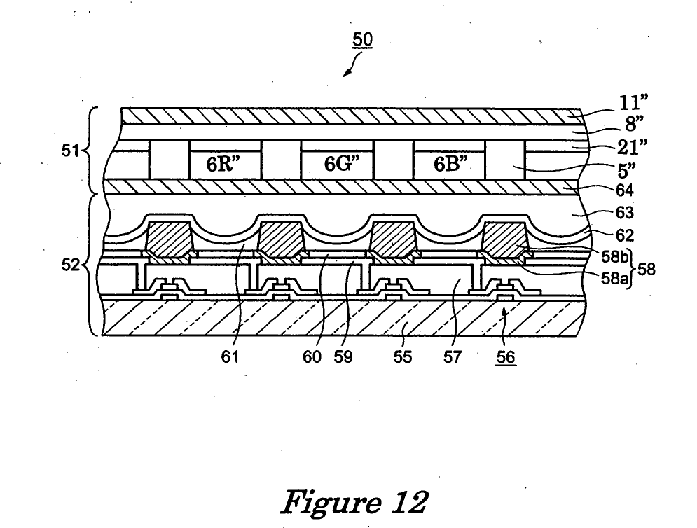

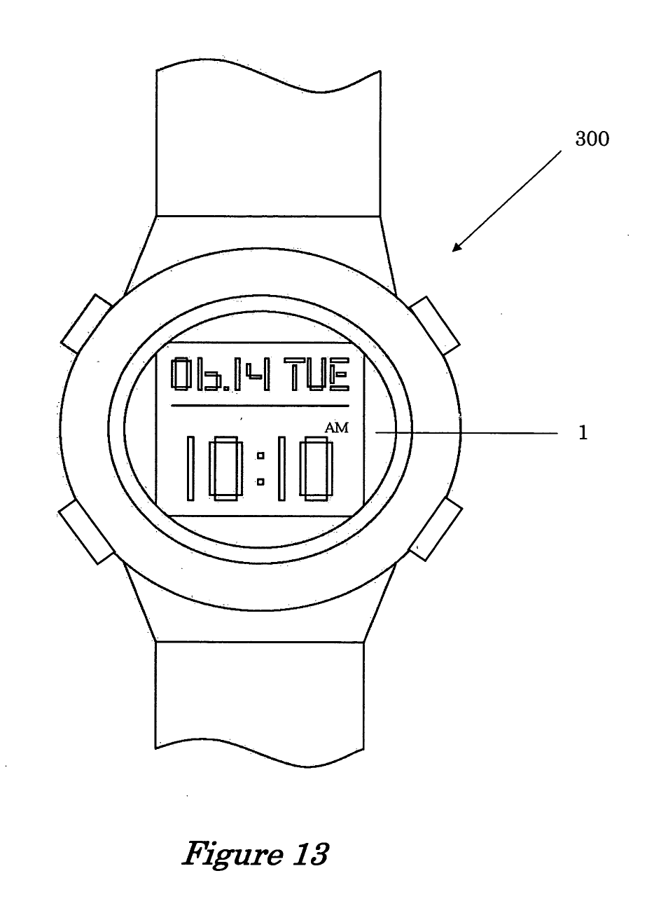

An electro-optic device in accordance with another embodiment of the present invention will be briefly described. The electro-optic device of the present embodiment is a display device in which a color filter provided with light-transmissive colorless boundary layers 5 is combined with an organic EL (electroluminescence) element for emitting white light. As depicted in FIG. 12, this electro-optic device 50 is composed of a color filter unit 51 and an organic EL unit 52.

The color filter unit 51 is composed of a front substrate 11″; a shared substrate 64 disposed opposite the front substrate 11″; a colorless boundary layer 5″ formed on the front substrate 11″ side of the shared substrate 64; red, green, and blue coloring layers 6R″, 6G″, and 6B″; a colorless boundary layer 5″; a colored boundary layer 21″; and an overcoat layer 8″ for covering the coloring layers 6R″, 6G″, and 6B″.

The organic EL unit 52 is composed of an EL substrate 55, a plurality of switching elements 56 formed on the EL substrate 55; an insulating film 57 formed on the switching elements 56, a plurality of EL pixel electrodes 59 formed on the insulating film 57, banks 58 composed of inorganic banks 58a and organic banks 58b formed between the plurality of EL pixel electrodes 59, a positive-hole transport layer 60 formed on the EL pixel electrodes 59, a white luminescent layer 61 formed on the positive-hole transport layer 60, and an EL counter electrode 62 provided so as to cover the luminescent layer 61 and the banks 58. Furthermore, the shared substrate 64 of the color filter unit 51 attached at the periphery of the EL substrate 55 is arranged on the EL counter electrode 62. Furthermore, an inert gas 63 is enclosed between the shared substrate 64 and the EL counter electrode 62, thus constituting the electro-optic device 50.

The EL substrate 55, shared substrate 64, and front substrate 11″ in the electro-optic device 50 thus configured are light-transmissive glass substrates. For example, the coloring layers 6R″, 6G″, and 6B″ of the color filter unit 51 are preferably arranged in a grid as depicted in FIG. 2. The luminescent layers 61, EL pixel electrodes 59, positive-hole transport layers 60, and EL counter electrodes 62 of the organic EL unit 52 are arranged opposite each of the coloring layers 6. The positive-hole transport layer 60 is positioned between the EL pixel electrodes 59 and the luminescent layer 61, and is designed to raise the efficiency of light emission by the luminescent layer 61. The EL pixel electrodes 59 and EL counter electrodes 62 may, for example, be light-transmissive ITO electrodes that are electrically connected to the switching elements 56 and that control the luminescence of the luminescent layer 61. The luminescent layer 61 emits white light. This white light is colored by one of the red, green, and blue coloring layers 6″, and exits from the front substrate 11″ as colored light. In other words, the organic EL unit 52 acts as a designated light source for each coloring layer 6R″, 6G″, and 6B″.

The positive-hole transport layer 60 and luminescent layer 61, which are essential components of the organic EL unit 52, can be efficiently formed by the droplet-discharging device 100. First, the EL substrate 55, on which the switching elements 56, insulating film 57, EL pixel electrodes 59, and banks 58 are formed, is mounted on the mounting platform 121 as the work 120 as shown in FIG. 6. The X-axis direction and Y-axis direction of the mounting direction are determined so as to correspond with those of the coloring layers 6R″, 6G″, and 6B″ depicted in FIG. 2. Droplets of material for forming the positive-hole transport layer 60 are discharged from the nozzles 117 while the discharge heads 116 move in the X-axis direction. Accordingly, droplets are deposited one by one to concave portions that are defined by the banks 58 and the EL pixel electrodes 59 and are lined up in the X-axis direction. The manufacture of the positive-hole transport layer 60 is completed by repeating this relative movement several times, depending on the positioning of the nozzles 117 and the number of rows of the concave portions in the Y-axis direction. After the droplets of materials for forming the positive-hole transport layer 60 are dried, droplets of an EL luminescent material are discharged onto the positive-hole transport layer 60. Accordingly, a luminescent layer 61 is formed in the same manner as with the positive-hole transport layer 60. After the process involving the droplet-discharging device 100 is completed, the luminescent layer 61 is dried and the EL counter electrode 62 is formed. The luminescent layer 61 and the EL counter electrode 62 are bonded together such that the coloring layers 6″ of the color filter unit 51 match the luminescent layer 61 of the organic EL unit 52. Lastly, an inert gas 63 is filled into the space between the EL counter electrode 62 and the shared substrate 64.

With this electro-optic device 50, the luminescent layers 61 of the organic EL unit 52 are arranged opposite the coloring layers 6R″, 6G″, and 6B″ of the color filter unit 51, such that luminescent layers 61 emit light only when their corresponding coloring layers 6″ of a color that needs to be displayed. Accordingly, it is possible to obtain an extremely low power-type display device. With the colorless boundary layers 5″ of the color filter unit 51, colorless bright light exits from the front substrate 11″, and the overall display is brightened and made easier to see. The organic EL unit 52 may also include an electronic emission element FED (Field Emission Display) and a SED (Surface Conduction Electron Emitter Display).

### Fourth Embodiment

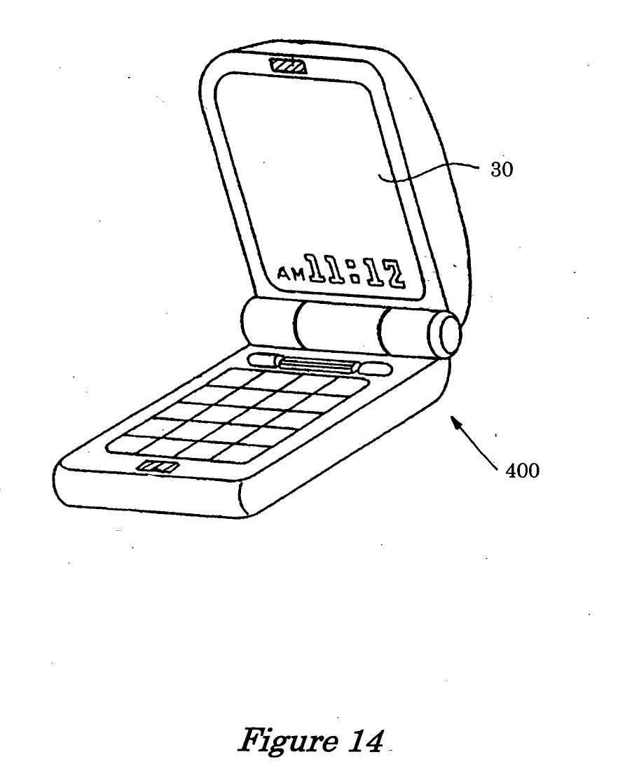

The color filter, liquid crystal display device, and electro-optic device of the present invention as described above can be installed in various electronic instruments that have a display unit, and specific examples thereof include mobile telephones, wristwatches, electronic dictionaries, mobile gaming devices, calculators, miniature televisions, personal computers, navigation devices, POS terminals, and the like. FIG. 13 shows a wristwatch 300 that includes a liquid crystal display device 1 as an example of an electronic instrument in accordance with the present embodiment. FIG. 14 shows a mobile telephone 400 that includes a liquid crystal display device 30 as another example of the electronic instrument in accordance with the present embodiment.

In the color filter of the present invention, coloring layers are compartmentalized in an orderly manner, such that an enhanced contrast can be obtained. Also, the boundary layer is made light-transmissive. Accordingly, the brightness can be maintained in reflected light and the brightness of the display can be enhanced.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

This application claims priority to Japanese Patent Application No. 2003-278432. The entire disclosure of Japanese Patent Application No. 2003-278432 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

1. A color filter comprising:
a light-transmissive substrate;
a reflecting layer formed on the substrate and provided with openings;
a boundary layer formed on the reflecting layer, and
a plurality of coloring layers enclosed by the boundary layer, wherein
the boundary layer includes a light-transmissive boundary layer portion that is disposed adjacent to the openings.

2. The color filter according to claim 1, wherein
the light-transmissive boundary layer portion is disposed at a plurality of locations that border adjacent coloring layers.

3. The color filter according to claim 1, wherein
the boundary layer further includes a non-light-transmissive boundary layer portion that is disposed adjacent to the openings.

4. The color filter according to claim 1, wherein
the coloring layers are formed by depositing droplets of a prescribed fluid with a discharging device.

5. The color filter according to claim 1, wherein
the boundary layer is formed in a grid.

6. The color filter according to claim 1, wherein
the plurality of coloring layers has a plurality of colors, and
the light-transmissive boundary layer portion is disposed between the coloring layers of different colors.

7. The color filter according to claim 3, wherein
the non-light-transmissive boundary layer portion is disposed between the coloring layers of the same color.

8. The color filter according to claim 3, wherein
the non-light-transmissive boundary layer portion is black.

9. A color filter comprising:
a light-transmissive substrate;
a reflecting layer formed on the substrate and provided with openings, the reflecting layer having an irregular surface that scatters light; and
a plurality of coloring layers formed on the reflecting layer.

10. The color filter according to claim 9, further comprising
a boundary layer formed on the reflecting layer such that the plurality of coloring layers is enclosed by the boundary layer,
the boundary layer including a light-transmissive boundary layer portion that is disposed adjacent to the openings.

11. The color filter according to claim 10, wherein
the light-transmissive boundary layer portion is disposed at a plurality of locations that border adjacent coloring layers.

12. The color filter according to claim 10, wherein
the boundary layer further includes a non light-transmissive boundary layer portion that is disposed adjacent to the openings.

13. The color filter according to claim 9, wherein
the coloring layers are formed by depositing droplets of a prescribed fluid with a discharging device.

14. The color filter according to claim 10, further comprising
an overcoat layer formed so as to cover the boundary layer and the coloring layers,
the overcoat layer being formed so that its thickness at a portion that corresponds to the irregular surface of the reflecting layer is greater than those at other portions of the overcoat layer.

15. The color filter according to claim 10, wherein
the boundary layer is formed in a grid.

16. The color filter according to claim 10, wherein
the plurality of coloring layers has a plurality of colors, and
the light-transmissive boundary layer portion is disposed between the coloring layers of different colors.

17. The color filter according to claim 12, wherein
the non-light-transmissive boundary layer portion is disposed between the coloring layers of the same color.

18. The color filter according to claim 12, wherein
the non-light-transmissive boundary layer portion is black.

19. An electronic instrument that is equipped with the color filter according to claim 1.

20. An electronic instrument that is equipped with the color filter according to claim 9.

21. A method of manufacturing a color filter, comprising:
providing a light-transmissive substrate;
forming a reflecting layer having an opening on the substrate;
forming on the reflecting layer a boundary layer that includes a light-transmissive boundary layer portion; and
forming a plurality of coloring layers on areas enclosed by the boundary layer.

22. The color filter manufacturing method according to claim 21, wherein
the light-transmissive boundary layer portion is formed by disposing the light-transmissive boundary layer portion at a plurality of locations that border the areas where the coloring layers are to be formed.

23. The color filter manufacturing method according to claim 21, wherein
the boundary layer is formed so as to define a plurality of deposit portions enclosed by the boundary layer, and
the coloring layers are formed by depositing to the deposit portions droplets of a prescribed fluid that are discharged by a discharging device.

24. A method of manufacturing a color filter, comprising:
providing a light-transmissive substrate;
forming a reflecting layer having an opening on the substrate, such that the reflecting layer has an irregular surface that scatters light;
forming on the reflecting layer a boundary layer;
forming a plurality of coloring layers on areas enclosed by the boundary layer; and
forming an overcoat layer so as to cover the boundary layer and the coloring layers.

25. The color filter manufacturing method according to claim 24, wherein the boundary layer includes a light-transmissive boundary layer portion.

26. The color filter manufacturing method according to claim 25 wherein the light-transmissive boundary layer portion is formed by disposing the light-transmissive boundary layer portion at a plurality of locations that border the areas where the coloring layers are to be formed.

27. The color filter manufacturing method according to claim 24, wherein
the boundary layer is formed so as to define a plurality of deposit portions enclosed by the boundary layer, and
the coloring layers are formed by depositing to the deposit portions droplets of a prescribed fluid that are discharged by a discharging device.

28. The color filter manufacturing method according to claim 24, wherein
the overcoat layer is formed so that its thickness at a portion that corresponds to the irregular surface of the reflecting layer is greater than those at other portions of the overcoat layer.

29. A display device comprising:
a front substrate;
a color filter that has
a light-transmissive back substrate,
a reflecting layer formed on the back substrate and provided with openings,
a boundary layer formed on the reflecting layer, the boundary layer including a light-transmissive boundary layer that is disposed adjacent to the openings, and
a plurality of coloring layers enclosed by the boundary layer;
a plurality of electrodes disposed so as to correspond to the coloring layers;
orientation films that cover the plurality of electrodes;
polarizing plates attached to the front and back substrates;
an optical waveguide plate provided so as to cover the polarizing plate attached to the back substrate; and
a light source for supplying light to the optical waveguide plate.

30. The display device according to claim 29, wherein
the light-transmissive boundary layer portion is disposed at a plurality of locations that border adjacent coloring layers.

31. The display device according to claim 29, wherein
the coloring layers are formed by depositing droplets of a prescribed fluid with a discharging device.

32. A display device comprising:
a front substrate;
a color filter that has
a light-transmissive back substrate,
a reflecting layer formed on the back substrate and provided with openings, the reflecting layer having an irregular surface that scatters light,
a boundary layer formed on the reflecting layer,
a plurality of coloring layers enclosed by the boundary layer, and
an overcoat layer formed so as to cover the boundary layer and the coloring layers;
a plurality of electrodes disposed so as to correspond to the coloring layers;
orientation films that cover the plurality of electrodes;
polarizing plates attached to the front and back substrates;
an optical waveguide plate provided so as to cover the polarizing plate attached to the back substrate; and
a light source for supplying light to the optical waveguide plate.

33. The display device according to claim 32, wherein
the boundary layer includes a light-transmissive boundary layer portion that is disposed adjacent to the openings.

34. The display device according to claim 33, wherein
the light-transmissive boundary layer portion is disposed at a plurality of locations that border adjacent coloring layers.

35. The display device according to claim 32, wherein
the coloring layers are formed by depositing droplets of a prescribed fluid with a discharging device.

36. The display device according to claim 32, wherein
the overcoat layer is formed so that its thickness at a portion that corresponds to the irregular surface of the reflecting layer is greater than those at other portions of the overcoat layer.

37. An electronic instrument equipped with the display device according to claim 29.

38. An electronic instrument equipped with the display device according to claim 32.

39. An electro-optic device comprising:
a color filter unit having
a boundary layer having a light-transmissive boundary layer portion, and
coloring layers that are enclosed by the boundary layer; and
an organic electroluminescence unit that provides light to each of the coloring layers.

40. An electronic instrument equipped with the electro-optic device according to claim 39.
